(19) United States
(12) Patent Application Publication
(10) Pub. No.: US 2025/0132661 A1
(43) Pub. Date: Apr. 24, 2025

(54) HYBRID SERIES/PARALLEL PIEZOELECTRIC-RESONATOR BASED DC-DC CONVERTER

(71) Applicant: THE REGENTS OF THE UNIVERSITY OF CALIFORNIA, Oakland, CA (US)

(72) Inventors: Wen-Chin Liu, La Jolla, CA (US); Patrick Mercier, La Jolla, CA (US)

(21) Appl. No.: 18/918,409

(22) Filed: Oct. 17, 2024

Related U.S. Application Data
(60) Provisional application No. 63/591,904, filed on Oct. 20, 2023.

(51) Int. Cl. H02M 1/00; H02M 3/00; H02M 3/158

(52) U.S. Cl. CPC H02M 1/0095; H02M 1/0058; H02M 3/01; H02M 3/158

(57) ABSTRACT

A DC-DC converter for converting an input voltage from a battery source includes a piezoelectric converter and a switched capacitor network between the battery source and the piezoelectric converter. The switched capacitor network provides a flying capacitor configured to be soft-charged and soft discharged due to an inductive operation of the piezoelectric converter such that charge-sharing loss of the flying capacitor is eliminated.

### PRIORITY CLAIM AND REFERENCE TO RELATED APPLICATION

The application claims priority under 35 U.S.C. § 119 and all applicable statutes and treaties from prior U.S. provisional application Ser. No. 63/591,904, which was filed Oct. 20, 2024.

### STATEMENT OF GOVERNMENT INTEREST

This invention was made with government support under grant 2052809 awarded by the National Science Foundation (NSF). The government has certain rights in the invention.

### TECHNICAL FIELD

A field of the invention is DC-DC voltage conversion, such as step-down conversion from a battery power source. Example applications of the invention include portable electronic devices, such as laptop computers, smart phones, internet-things-of-interest (IoT) and tablets.

### BACKGROUND

Almost all battery-powered devices require some DC-to-DC stepdown to convert the output of the battery to a lower voltage required by certain components. Inevitably, some loss and inefficiency accompanies the step-down conversion, which reduces battery life and performance. Convertors also take up board space and make electronics physically larger.

Portable electronic devices, such as laptops computers, smart phones, IoTs and tablets, are powered by Lithium-ion batteries. Typical Li-ion battery voltages on mobile devices are much greater than the operating voltages for the various chip components. Typical Li-Ion batteries have voltage ratings in the range of 2.8-4.2 volts. Modern processors and electronics included in portable electronic devices operate at about 1 volt or less, typically 0.6-1.0V. DC-to-DC power converters are employed to reduce the battery voltage to useable levels for different components around the chip. The required step-down of voltage should also maximize battery life.

Due to their planar form factor, ease of batch fabrication, and linear scaling properties, piezoelectric devices have garnered significant attention toward the design of small, lightweight, and high-efficiency power converters [Ref. 1]-[Ref. 7]. Typically, magnetic components can be shrunk as the operating frequency increases; however, the size reduction is not necessarily linear in relation to the increment of frequency, limiting miniaturization possibilities [Ref. 8]. On the other hand, piezoelectric devices generally scale linearly with their resonant frequencies, and therefore, emerging compact converters with high achievable efficiency and power density are becoming possible.

Among piezoelectric devices, piezoelectric resonators (PRs) are reported to show high power density and high-efficiency [Ref. 9]-[Ref. 11]. FIG. 1 shows one such high-efficiency PR-based converters. By operating the PR in the inductive resonating region, zero-voltage switching (ZVS) and soft-charging of the PR's junction capacitance can be achieved, leading to low overall losses conversion deviates from the optimal point [Ref. 12]. Unfortunately, many step-down converter applications require a much larger conversion ratio, limiting the appeal of a baseline PR-based step-down converter to broad application spaces. A better way is to integrate the cascaded converter into the original baseline converter without changing the control law, such as has been popularized by prior hybrid capacitive/inductive converters. [Ref. 12].

### REFERENCES

[Ref. 1] G.-S. Seo, J.-W. Shin, and B.-H. Cho, “A magnetic component-less series resonant converter using a piezoelectric transducer for low profile application,” in The 2010 International Power Electronics Conference ECCE ASIA-, 2010, pp. 2810-2814.
[Ref. 2] J. D. Boles, E. Ng, J. H. Lang, and D. J. Perreault, “Dc-dc converter implementations based on piezoelectric transformers,” IEEE Journal of Emerging and Selected Topics in Power Electronics, pp. 1-1, 2021.
[Ref. 3] B. Pollet, G. Despesse, and F. Costa, “A new non-isolated low-power inductorless piezoelectric dc-dc converter,” IEEE Transactions on Power Electronics, vol. 34, no. 11, pp. 11002-11013, 2019.
[Ref. 4] B. Pollet, F. Costa, and G. Despesse, “A new inductorless dc-dc piezoelectric flyback converter,” in 2018 IEEE International Conference on Industrial Technology (ICIT), 2018, pp. 585-590.
[Ref. 5] B. Pollet, G. Despesse, and F. Costa, “A new non-isolated low-power inductorless piezoelectric dc-dc converter,” IEEE Transactions on Power Electronics, vol. 34, no. 11, pp. 11002-11013, 2019.
[Ref. 6] E. L. Horsley, A. V. Carazo, N. Nguyen-Quang, M. P. Foster, and D. A. Stone, “Analysis of inductorless zero-voltage-switching piezoelectric transformer-based converters,” IEEE Transactions on Power Electronics, vol. 27, no. 5, pp. 2471-2483, 2012.
[Ref. 7] C. Lin and F. Lee, “Design of a piezoelectric transformer converter and its matching networks,” in Proceedings of 1994 Power Electronics Specialist Conference—PESC′94, vol. 1, 1994, pp. 607-612 vol. 1.
[Ref. 8] C. R. Sullivan, B. A. Reese, A. L. F. Stein, and P. A. Kyaw, “On size and magnetics: Why small efficient power inductors are rare,” in 2016 International Symposium on 3D Power Electronics Integration and Manufacturing (3D-PEIM), 2016, pp. 1-23.
[Ref. 9] J. D. Boles, P. L. Acosta, Y. K. Ramadass, J. H. Lang, and D. J. Perreault, “Evaluating piezoelectric materials for power conversion,” in 2020 IEEE 21st Workshop on Control and Modeling for Power Electronics (COMPEL), 2020, pp. 1-8.
[Ref. 10] M. Touhami, G. Despesse, and F. Costa, “A new topology of dc-dc converter based on piezoelectric resonator,” IEEE Transactions on Power Electronics, vol. 37, no. 6, pp. 6986-7000, 2022.
[Ref. 11] W. D. Braun, Z. Tong, and J. Rivas-Davila, “Inductorless soft switching dc-dc converter with an optimized piezoelectric resonator,” in 2020 IEEE Applied Power Electronics Conference and Exposition (APEC), 2020, pp. 2272-2278.
[Ref. 12] J. D. Boles, J. J. Piel, and D. J. Perreault, “Enumeration and analysis of dc-dc converter implementations based on piezoelectric resonators,” IEEE Transactions on Power Electronics, vol. 36, no. 1, pp. 129-145, 2021.
[Ref. 13] K. Van Dyke, “The piezo-electric resonator and its equivalent network,” Proceedings of the Institute of Radio Engineers, vol. 16, no. 6, pp. 742764, 1928.
[Ref. 14] B. Pollet, M. Touhami, G. Despesse, and F. Costa, “Effects of discshaped piezoelectric size reduction on resonant inductorless dc-dc converter,” in 2019 20th International Conference on Solid-State Sensors, Actuators and Microsystems & Eurosensors XXXIII (TRANSDUCERS & EUROSENSORS XXXIII), 2019, pp. 1423-1426.

### SUMMARY OF THE INVENTION

A preferred embodiment provides a DC-DC converter for converting an input voltage from a battery source. The converter includes a piezoelectric converter and a switched capacitor network between the battery source and the piezoelectric converter. The switched capacitor network provides a flying capacitor configured to be soft-charged and soft discharged due to an inductive operation of the piezoelectric converter such that charge-sharing loss of the flying capacitor is eliminated. The converter can include an output a switched capacitor network between the piezoelectric converter and an output, wherein the switched capacitor network provides a backside flying capacitor configured to be self-balanced by the piezoelectric converter.

A preferred embodiment provides a DC-DC converter for converting an input voltage from a battery source. The converter includes a piezoelectric converter and a switched capacitor network between the piezoelectric converter and an output. The switched capacitor network provides a flying capacitor is configured to be soft-charged and soft discharged due to an inductive operation of the piezoelectric converter such that charge-sharing loss of the flying capacitor is eliminated.

### BRIEF DESCRIPTION OF THE DRAWINGS

FIG. 1 (Prior Art) shows a prior high-efficiency PR-based converter;

FIG. 2 is a circuit diagram of a preferred series/parallel piezoelectric resonator converter;

FIG. 3 shows operational waveforms of the converter of FIG. 2;

FIGS. 4A-4H show operational phases of the converter of FIG. 2;

FIG. 5 shows the steady state waveforms over one piezoelectric resonator cycle for the converter of FIG. 2;

FIG. 6 show a lossy model of the converter of FIG. 2;

FIGS. 7A and 7B are a comparison of the lossy and lossless models along with simulation results under a 48/10 SPPR converter of FIG. 2 at 5 W output with a PR mechanical resistor of 2.4Ω;

FIG. 8 is a circuit diagram of a preferred dual side series/parallel piezoelectric resonator converter;

FIG. 9 shows operational waveforms of the converter of FIG. 8;

FIGS. 10A-10H show operational phases of the converter of FIG. 8;

FIG. 11 shows the steady state waveforms over one piezoelectric resonator cycle for the converter of FIG. 8;

FIG. 12 is a circuit diagram of a preferred merged series/parallel piezoelectric resonator converter;

FIG. 13 shows operational waveforms of the converter of FIG. 12; and

FIGS. 14A-14G show operational phases of the converter of FIG. 12.

### DETAILED DESCRIPTION OF THE PREFERRED EMBODIMENTS

A preferred embodiment is series/parallel piezoelectric resonator (SPPR) DC-to-DC converter with an improved hybrid dual-side series/parallel piezoelectric resonator with a switched capacitor network on the input and output sides. Another embodiment includes a switched capacitor network on only one side. Both designs can improve the performance of a PR-based converter when a high voltage step-down ratio is required. A prototype of a single side switched capacitor embodiment demonstrated a 14.17% efficiency improvement compared to the baseline PR converter at a 48/10V DC-DC stepdown. A prototype of a dual side switched capacitor embodiment demonstrated a 17.1% improvement for 20/2.2V DC-DC stepdown. The single and dual side switched capacitor networks are comparatively better suited to certain stepdown ratios. Both designs reduce the required chip area significantly compared to other PR convertor designs.

A preferred embodiment provides a series/parallel piezoelectric resonator (SPPR) converter that includes a pre-step-down SC network integrated into the converter in a similar manner to a hybrid capacitive/inductive converter. An optimal operation point of the entire converter is shifted to a larger step-down ratio while maintaining most of the benefits of traditional PR-based converters, including soft-charged/discharged of the PR's junction capacitor and zero-voltage switching of most power switches. Beneficially, a flying capacitor of the SC network can be soft-charged/discharged due to the inductive operation of the PR, eliminating the charge-sharing loss of the flying capacitor. Hence, the SPPR converter can achieve higher efficiency compared to the conventional PR converter at a given operable conversion ratio. The preferred embodiment is especially useful to improve the performance of a PR-based converter when a higher step-down ratio is required.

The hybrid-type piezoelectric converter integrates a switched capacitor (SC) network into a PR converter. With the help of the SC network, the performance at a larger conversion ratio can be improved. The design can provide a compact dc-dc converter that is useful, for example, for consumer electronics applications.

A preferred embodiment is a Dual-side Series/Parallel Piezoelectric-Resonator-based (DSPPR) converter that can improve the performance of PR-based converters when a higher step-down ratio is required. An additional step-down capability of SC networks integrated into both sides (input/output side) converter in a similar manner to a hybrid capacitive/inductive converter. The optimal operation point of the entire converter is shifted to a larger step-down ratio while maintaining most of the benefits of traditional PR-based converters, including soft-charged/discharged of the PR's junction capacitor and zero-voltage switching (ZVS) of most power switches. Beneficially, the frontside (input side) flying capacitor can be soft-charged/discharged due to the inductive operation of the PR, eliminating the charge-sharing loss of the flying capacitor, and on the other hand, the backside (output side) flying capacitor is self-balanced leading to ZVS on switches added to backside network. Hence, the preferred DSPPR converter can achieve higher efficiency compared to the conventional PR converters at a given operable conversion ratio.

The preferred DSPPR converter is believed to be the first PR-based converter reported that operates at a low VCR (<0.1) with a decent efficiency (88% at 20V−2.2V at 0.1 A output), achieving a 310% loss reduction compared to the co-design baseline PR converter. It is also believed to be the first PR-based converter implemented by an integrated circuit reducing area by 13-23× compared to baseline PR and Frontside Series/Parallel PR-based (FSPPR) converters.

Preferred embodiments of the invention will now be discussed with respect to experiments and drawings. Broader aspects of the invention will be understood by artisans in view of the general knowledge in the art and the description of the experiments that follows.

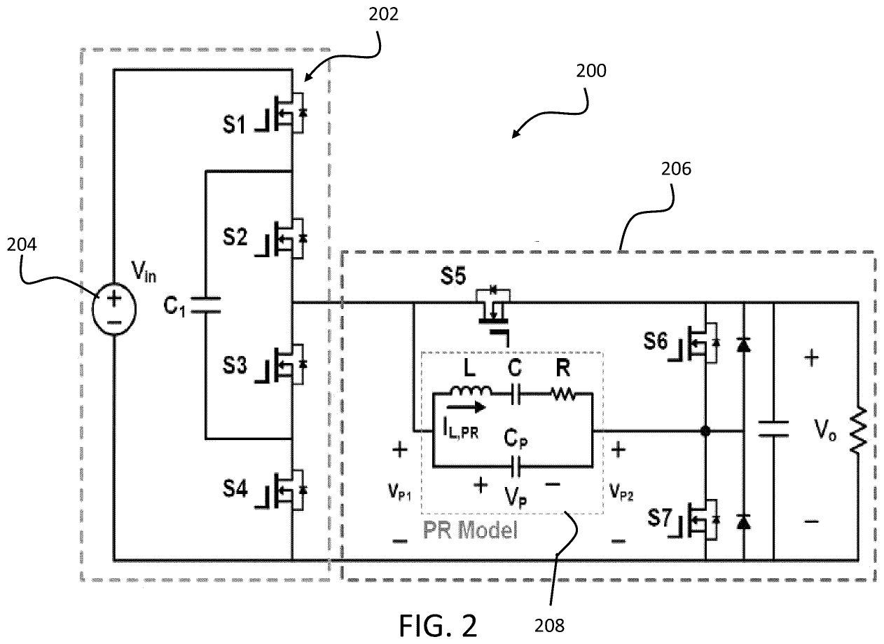

FIG. 2 is a shows a preferred series/parallel piezoelectric resonator converter 200. A switched capacitor network 202 is between a battery source 204 and a piezoelectric converter 206. The switched capacitor network provides a flying capacitor C₁ that can be soft-charged/discharged due to the inductive operation of the piezoelectric converter 206 to eliminate the charge-sharing loss of the flying capacitor C₁.

A piezoelectric resonator (PR) 208 in the piezoelectric converter 206 represented by the Butterworth-Van Dyke (BVD) model [Ref. 13]. In the PR model, R, L, and C refer to the mechanical part of PRs, while C_{P} refers to the junction capacitor.

The switched capacitor network 202 is a switched-capacitor pre-step-down stage, where switches S1-S4 and flying capacitor C1 switch between series and parallel modes. In the series mode, S1 and S3 are turned on, putting C₁ in series with the PR-based stage. In the parallel mode, S2 and S4 are turned on, putting C₁ in parallel with the PR-based piezoelectric converter stage 206. By this flying capacitor mechanism, C₁ is clamped to half the input voltage, lowering the voltage stress of the switches in the SC network and the equivalent input voltage to the PR-based piezoelectric converter stage 206.

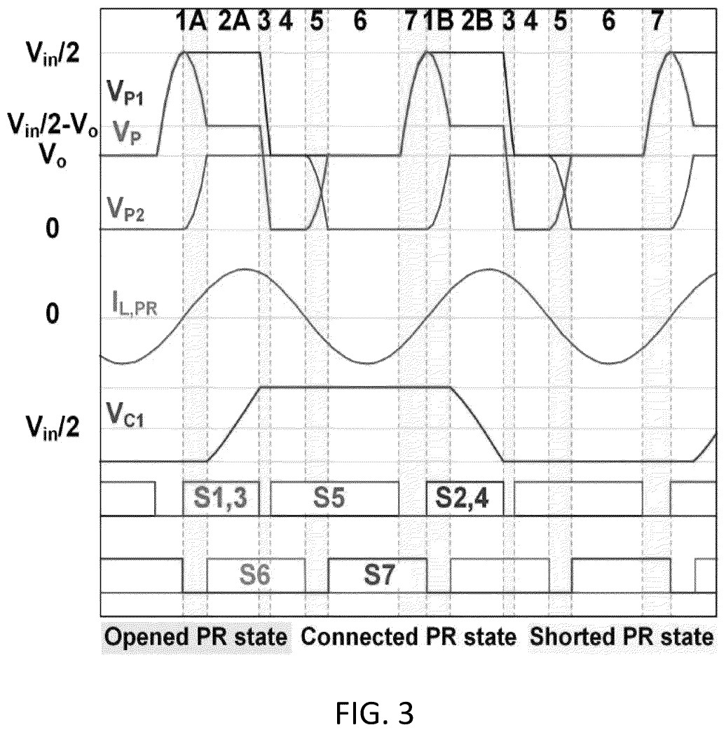

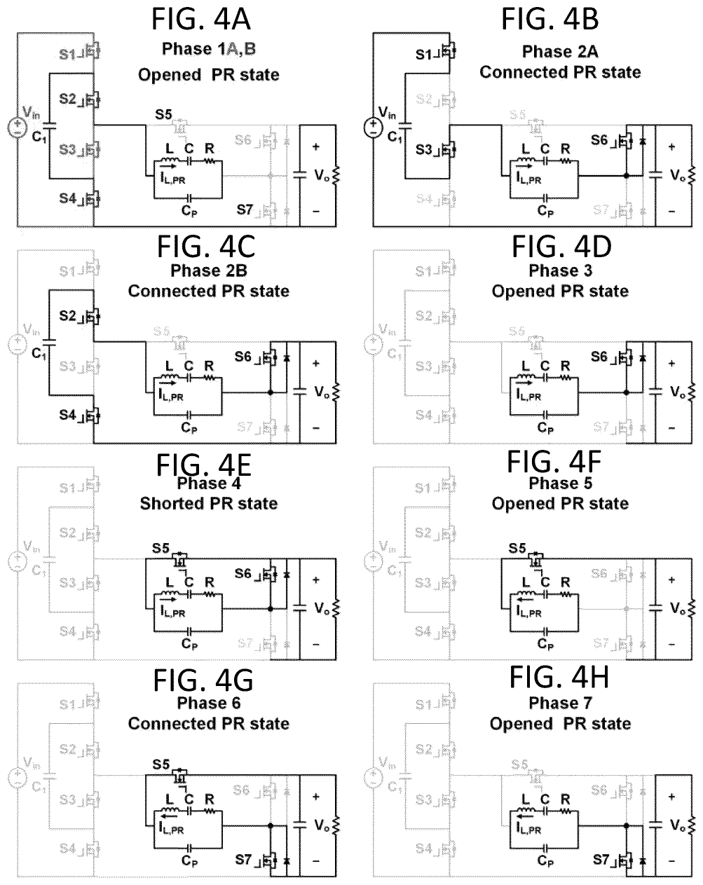

FIG. 3 shows operational waveforms of the converter 200. FIGS. 4A-4H show operational phases of the converter 200. The converter operates over a sequence of 7 individual phases in a repeating manner with a period set by the SC circuit, with 2 of the 7 phases having alternating connection modes to ensure flying capacitor charge balancing. Across the 7 phases, there are 3 possible states the PR can be in: a connected PR state, a shorted PR state, and an opened PR state. No switch connects the output of the PR in phases 1 A and 1B, and thus in this opened PR state, the inductive PR current, I_{L,PR}, internally discharges junction capacitor, C_{P}, which charges V_{P2} until it reaches Vₒ to enable ZVS for S6. In phase 1 A, the flying capacitor, C₁, is connected in the up (series) position, while in the next cycle in phase 1 B, C₁, is connected in the down (parallel) position. In either case, once there is zero voltage across S6, it is turned on, connecting the PR to the output and beginning phases 2 A and 2B, where the PR delivers energy from input to output while soft-charging flying capacitor C₁ via I_{L,PR} (series operation) in 2 A, or soft-discharging C₁ via I_{L,PR} (parallel operation) in 2B, ensuring charge balance of C₁. Then, switches S1-S4 are all opened in phase 3, open circuiting the PR, where I_{L,PR} internally discharges C_{P} until V_{P1}=Vₒ to enable ZVS for S5. Once V_{P1}=Vₒ, S5 is also turned on with S 6, shorting the PR to ensure the continuity of the resonant current. This phase ends when I_{L,PR} crosses zero and reserves its polarity.

At this point, S6 is turned off, beginning phase 5, where the PR is now in the opened state, and I_{L,PR} charges C_{P}, thereby discharging V_{P2} until it reaches zero to enable ZVS turn-on of S7. At this point, S7 turns on in phase 6, connecting the PR to the output via ground, thereby releasing stored energy to the load. Phase 7 begins when S5 turns off, opening the PR, where I_{L,PR} charges C_{P} until V_{P1} reaches V_{IN}, minimizing switching loss across S1,3/S2,4 in the next SC cycle.

### Voltage Conversion Ratio and PR Utilization

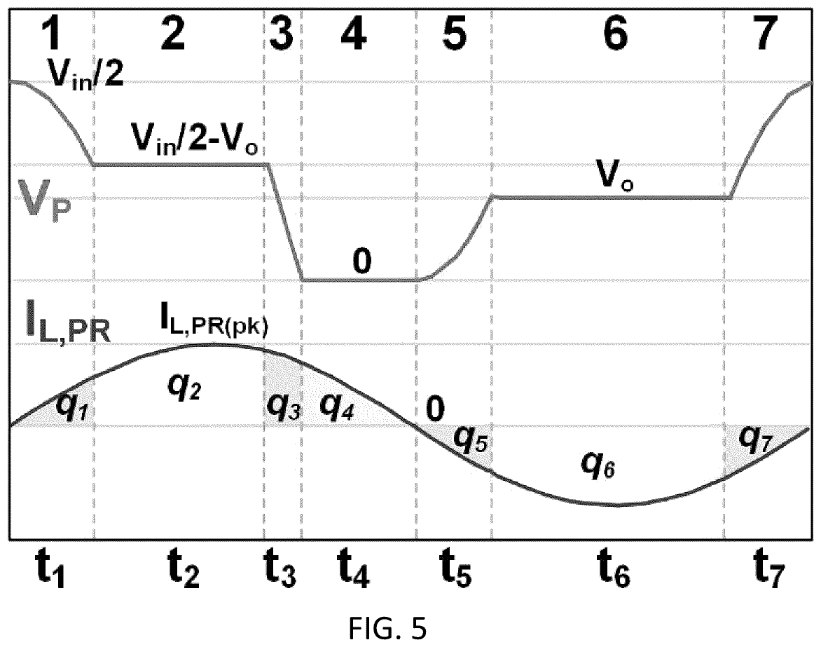

FIG. 5 shows steady-state waveforms over a PR cycle of the converter 200. In the steady-state operation over a cycle, a PR must follow the conservation of charge (CoC) and conservation of energy (CoE) to balance the charge and energy. Therefore, the CoC of C and C_{P} must hold in (1) and (2) where qₙ is the charge in each phase:

$${q}_{1} + {q}_{2} + {q}_{3} + {q}_{4} + {q}_{5} + {q}_{6} + {q}_{7} = 0 \qquad ( 1 )$$

$${q}_{1} + {q}_{3} + {q}_{5} + {q}_{7} = 0 \qquad ( 2 )$$

by substituting (2) into (1), it can be found that the charge transfer must be balanced in the connected and shorted states, which is expressed as:

$${q}_{2} + {q}_{4} + {q}_{6} = 0 \qquad ( 3 )$$

Then, inserting (3) into (4) using q₆=−(q₂+q₄), the voltage conversion ratio of the SPPR converter 200 can be found as:

$$0 \leq \frac{{V}_{o}}{{V}_{i n}} = \frac{1}{2} \frac{{q}_{2}}{2 {q}_{2} + {q}_{4}} \leq \frac{1}{4} \qquad ( 5 )$$

It can be observed that the voltage conversion ratio depends on the ratio of the charge in the connected state, phase 2, and the shorted state, phase 4, within the positive cycle of I_{L,PR}. By assuming that the charge in opened states, phases 1 and 3, are small and negligible, the VCR reaches its maximum value, which equals 0.25, when the duration of phase 2 is the entire positive cycle of I_{L,PR}; on the other hand, the VCR reaches its minimum value, which equals 0, when the duration of phase 4 equals the entire positive cycle of I_{L,PR} implying zero energy transfer. Compared to the baseline PR based converter presented in [Ref 12], the voltage conversion ratio range is halved due to the pre-step-down SC network, which reduces the effective input voltage for the PR stage and leads to a more efficient operation of the PR at a higher step-down scenario.

The PR utilization factor, K, first introduced in [Ref 12], is a factor in evaluating how efficient the PR is in a specific implementation and phase sequence regardless of material, size, loss coefficients, etc. The PR utilization factor is defined by the idea of effective charge transferred, which is the portion of the charge in the connected and shorted states that are finally delivered to the output.

Here, the PR utilization factor of the SPPR converter can be defined as:

$$K = \frac{\vert {q}_{2} \vert + \vert {q}_{6} \vert}{\vert {q}_{2} \vert + \vert {q}_{4} \vert + \vert {q}_{6} \vert} \qquad ( 6 )$$

Substituting (3) and (4) into (6), the PR utilization factor can be rearranged into a form of Vᵢₙ and Vₒ, which is shown in (7):

$$0.5 \leq K = \frac{{V}_{i n}}{2 ( {V}_{i n} - 2 {V}_{o} )} \leq 1 \qquad ( 7 )$$

According to (7), K is 1 when the VCR equals 0.25, and K is 0 when VCR equals 0, implying that the PR is most efficient when the SPPR converter 200 operates at the maximum conversion ratio where the duration of the resonant current circulating phase, phase 4, is minimum. That is to say that as VCR reduces, K reduces as well, showing an inefficient use of the PR, and resulting in overall efficiency reduction. Compared to the baseline PR-based converter in [Ref 12], (5) and (7) show that the optimal efficiency is shifted down from the conversion ratio of 0.5 to 0.25, which is more suitable for a higher step-down application.

### Charge Transfer and PR Resonant Current Under a Lossy Model

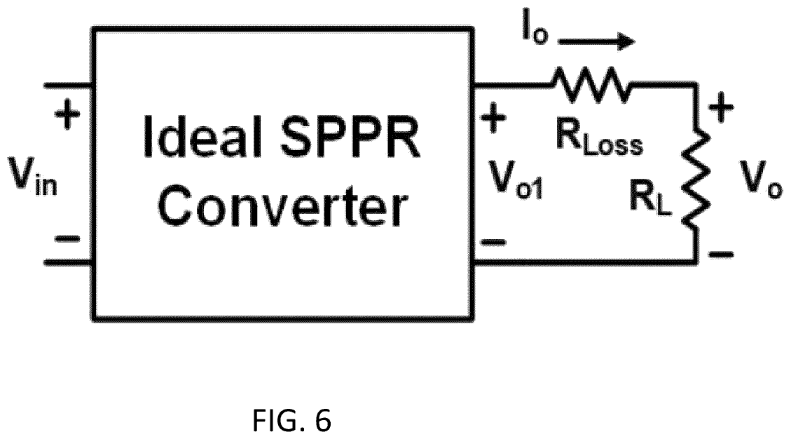

FIG. 6 shows a lossy model of the converter 200. To derive the PR resonant current, I_{L,PR}, for mechanical loss, the total charger transferred and stored in the PR must be first addressed. There are two parts of charge transferred or stored in the PR: 1) Qₒᵤₜ, which are transferred to the output, and 2) Q_{ZVS}, that are used to soft charge/discharge C_{P} for ZVS turn-on. Therefore, the total charge can be expressed as:

$${Q}_{t otal} = {Q}_{o u t} + {Q}_{Z V S} = \frac{{I}_{o}}{K f} + {C}_{P} {V}_{i n} \qquad ( 8 )$$

On the other hand, the total charge can also be expressed in terms of I_{L,PR} as:

$${Q}_{total} = 2 {\int }_{0}^{\frac{1}{2 f}} {i}_{L , PR} ( t ) dt \qquad ( 9 )$$

Where,

i_{L,PR}(t)=I_{L,PR(pk)}sin(ωt)

By equating (8) and (9), the amplitude of the PR resonant current, I_{L,PR(pk)}, can be derived:

$${I}_{L , PR ( p k )} = \frac{π}{2} ( \frac{{I}_{o}}{K} + f {C}_{P} {V}_{i n} ) \qquad ( 10 )$$

Here, the I_{L,PR(pk)} is derived in the ideal (lossless) condition; however, sometimes, the losses inside the PR may make the I_{L,PR(pk)} in (10) inaccurate in practice, where the calculation should be derived for Vₒ₁/Vᵢₙ conversion ratio instead of Vₒ/Vᵢₙ, as shown in FIG. 6. Therefore, the I_{L,PR(pk)} should be modified to include the amplitude difference caused by losses.

Due to the introduction of the lossy resistor, R_{Loss}, K in the lossy model can be expressed as:

$${K}_{l o s s y} = \frac{{V}_{i n}}{2 ( {V}_{i n} - 2 {V}_{o 1} )} = \frac{{V}_{i n}}{2 ( {V}_{i n} - 2 ( 1 + \frac{{R}_{{L}_{L o s s}}}{{R}_{L}} ) {V}_{o} )} \qquad ( 11 )$$

Then, (11) can be inserted to (10) to get the I_{L,PR(pk)} with the losses effect where R_{Loss} can be found in (12), which is derived by equating the losses in the PR and losses in the Thevenin equivalent loss resistance, as I_{LPR,(pk)}²R=IₒR_{Loss}·V_{in,PR} in (12) is the effective input voltage of the PR stage, which is Vᵢₙ/2 in the converter 200.

Where,

$$\begin{matrix}a = {( \frac{π {P}_{o}}{{V}_{i n , PR} {R}_{L}} )}^{2} , c = {{π}^{2} ( f {C}_{P} {V}_{i n , PR} + {I}_{o} - \frac{{P}_{o}}{{V}_{i n , PR}} )}^{2} \\ b = - \frac{2}{{R}_{L}} [ {π}^{2} ( f {C}_{P} {V}_{i n , PR} + {I}_{o} - \frac{{P}_{o}}{{V}_{i n , PR}} ) \frac{{P}_{o}}{{V}_{i n , PR}} + {I}_{o}^{2} \frac{{R}_{L}}{R} ]\end{matrix}$$

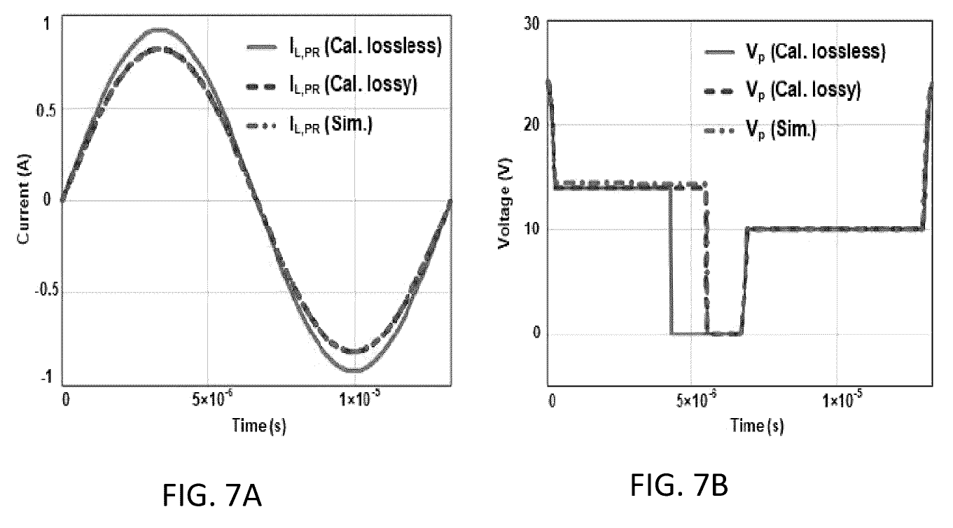

FIGS. 7A and 7B are a comparison of the lossy and lossless models along with simulation results under a 48/10 SPPR converter at 5 W output with a PR mechanical resistor of 2.4Ω, which is obtained from [Ref. 12]. The lossless model overestimates the resonant current, while the FIG. 6 lossy model accurately predicts the behavior of the PR converter. With the lossy model, the efficiency can be more accurately estimated, and the achievable operation range can be better predicted, providing better insights while designing a specific PR based converter consistent with the FIG. 2 converter and selecting appropriate PRs.

With I_{L,PR(pk)} calculated from (10)-(12), the loss of the PR can be written as:

$${P}_{l oss , PR} = \frac{1}{2} {I}_{L , PR ( p k )}^{2} R \qquad ( 13 )$$

### Dual-Side Series/Parallel Piezoelectric-Resonator-Based (DSPPR)

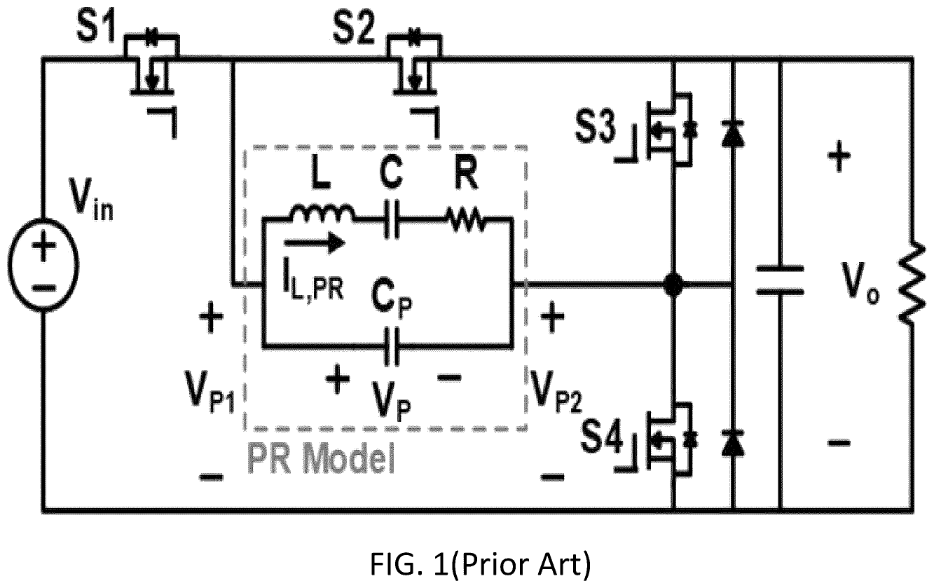

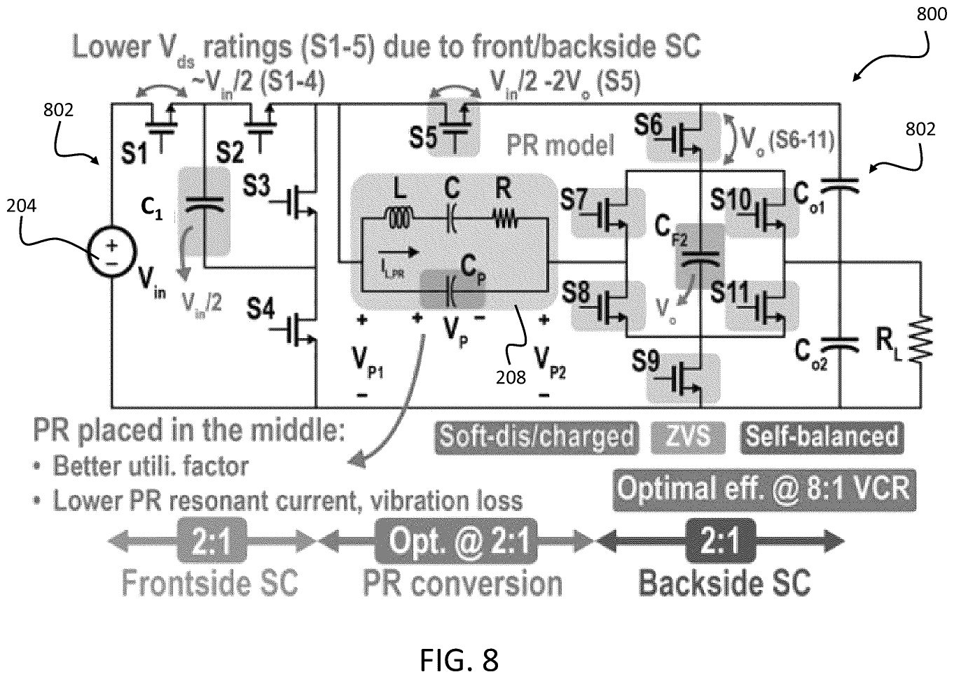

FIG. 8 is a circuit diagram of a preferred Dual-side series/parallel piezoelectric resonator converter 800. The converter 800 merges 2:1 series/parallel switched capacitor networks 802 at both its input (frontside) from the input voltage 204 and output (backside—across load resistor R_{L}) without causing cascaded losses. This can provide an optimal voltage conversion ratio (VCR) of 0.125 while reducing active area (switch and driver) thanks to IC integration by 13-23× compared to discrete designs. The converter 800 exploits transistor stacking to reduce voltage stress on power transistors from (Vᵢₙ−Vₒ) on S1 to S5 to (˜Vᵢₙ/2) on S1 to S4 and (Vᵢₙ/2−Vₒ) on S5, which reduces the cumulative VA (=V_{ds}×Iᵣₘₛ) rating across S1 to S5 by 67% compared to the FIG. 1 PR converter and reduces the transistor area by 60%. The converter 800 positions the PR 208 in the middle of the converter, where the equivalent input/output voltage of the PR 208 are respectively lower and higher compared to the FIG. 1 PR converter, leading to a 7× PR loss reduction and 2.5× increased output current capability. The converter 800 maintains zero-voltage switching ZVS of S5 to S9 and soft charging of C_{P} by keeping the same general operating phases as the FIG. 1 PR converter. The converter 800 soft-charges the frontside flying capacitor, C₁, via the inductive nature of the PR 208. The converter 800 self-balances a backside flying capacitor, C_{F2}, enabling ZVS for S10 and S11. A prototype demonstrated loss reduction of 310% and 212% and overall efficiency improvement of 17.1% and 9.9% compared to a co-fabricated discrete baseline PR converter of FIG. 1 and the converter 200, respectively, at 20V-to-2.2V, 0.1 A with the same PR 208.

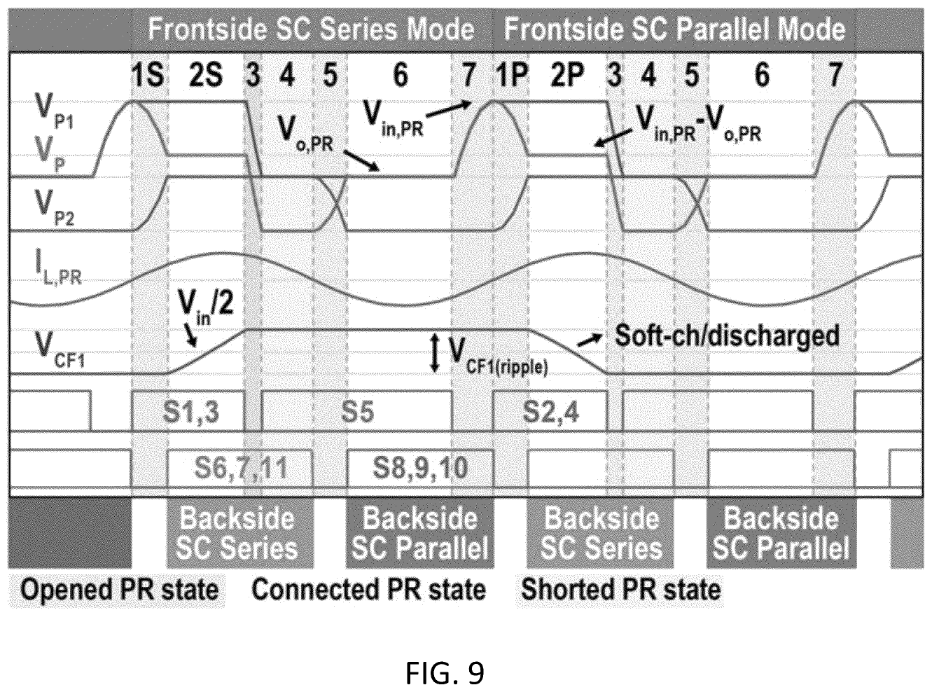

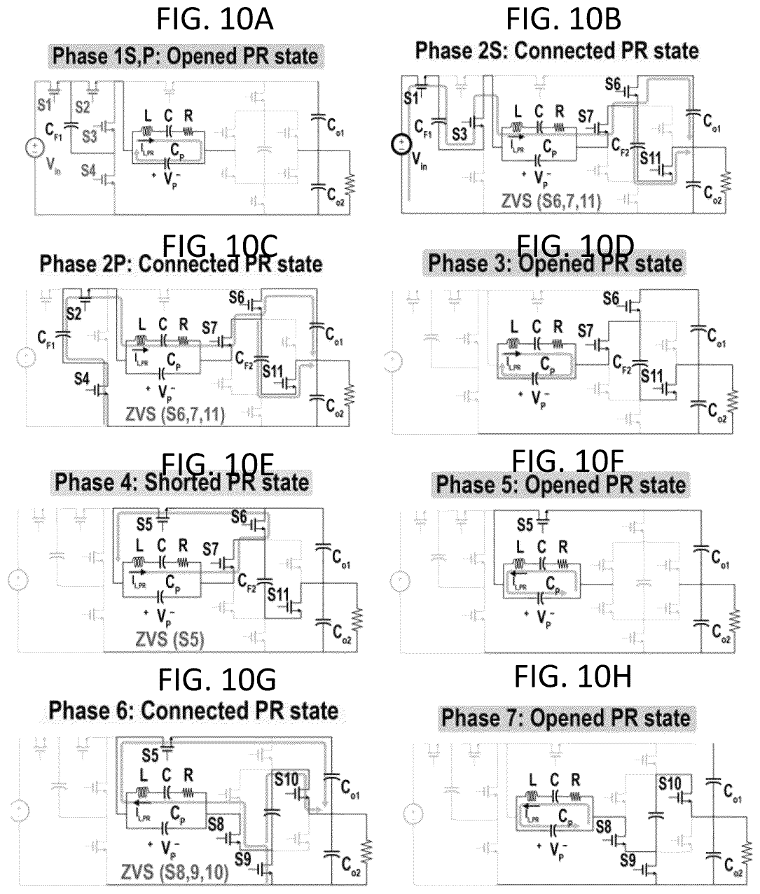

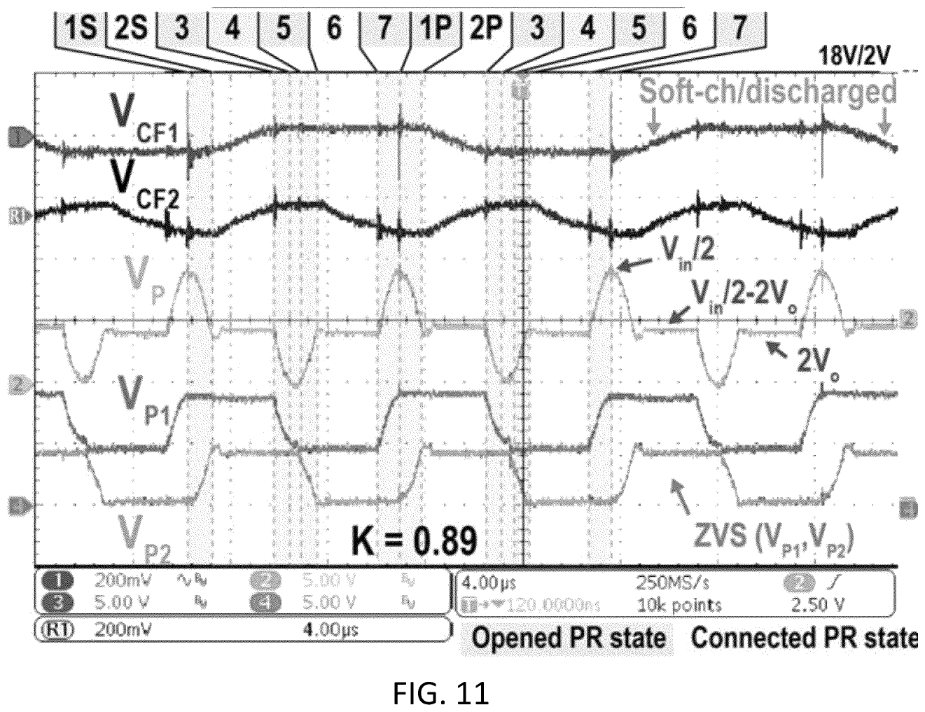

FIG. 9 shows operational waveforms of the converter 800. FIG. 11 shows the steady state waveforms over one piezoelectric resonator cycle for the converter 800. The operation principle of the converter 800 is the same as the FIG. 1 PR converter in that there is a sequence of 7 phases, yet here phases 1 and 2 alternate their connection (series, S, or parallel, P) to the frontside SC circuit 802 such that control complexity is not increased. Throughout the 7 phases, the PR 208 can be in one of three states: (1) opened PR, (2) connected PR, and (3) shorted PR. Initially, there are no current paths formed by switches in phase 1, and hence, in this opened PR state, the sinusoidal current formed by the PR, I_{L,PR}, discharges C_{P}. In phase 1S, C₁ is connected in the up (series) position, while in the subsequent cycle, in phase 1P, C₁ is connected in the down (parallel) position. Once V_{P2} reaches V_{o,PR}, S6, S7, and S11 are activated with ZVS, and phase 2 begins, connecting the PR to the input and output for energy delivery. Here, C₁ is soft-charged in phase 2S and soft-discharged in phase 2P due to I_{L,PR}, ensuring charge balance. On the other hand, C_{F2} is in series with the load in both phases 2S and 2P. Phase 3 starts with deactivating switches S1 to S4, enabling the opened PR state, where I_{L,PR} discharges C_{P} until V_{P1}=V_{o,PR}, enabling ZVS turn-on for S5. Then, phase 4 initiates, forming a shorted loop where I_{L,PR} circulates until its polarity reverses, after which switches S6, S7, and S11 are opened. This brings the PR back to an open PR state in phase 5, discharging V_{P2} until it reaches zero and enabling ZVS turn-on for S8 to S10. At this point, C_{F2} is in parallel with the load, and the PR is linked to the output, allowing the PR 208 to release energy to the load. Phase 7 begins when S5 turns off, opening the PR 208, where I_{L,PR} charges C_{P} until V_{P1} reaches V_{in,PR}, minimizing switching loss across S1,S3/S2,S4. FIGS. 10A-10H show operational phases of the converter 800 of FIG. 8. Steady-state measurements of an experimental IC consistent with the converter 800 in FIG. 11 reveal that CFI undergoes soft-charging/discharging through I_{L,PR}, achieving ZVS across S5 to S11.

### Merged Series/Parallel Piezoelectric-Resonator-Based DC-DC Converter

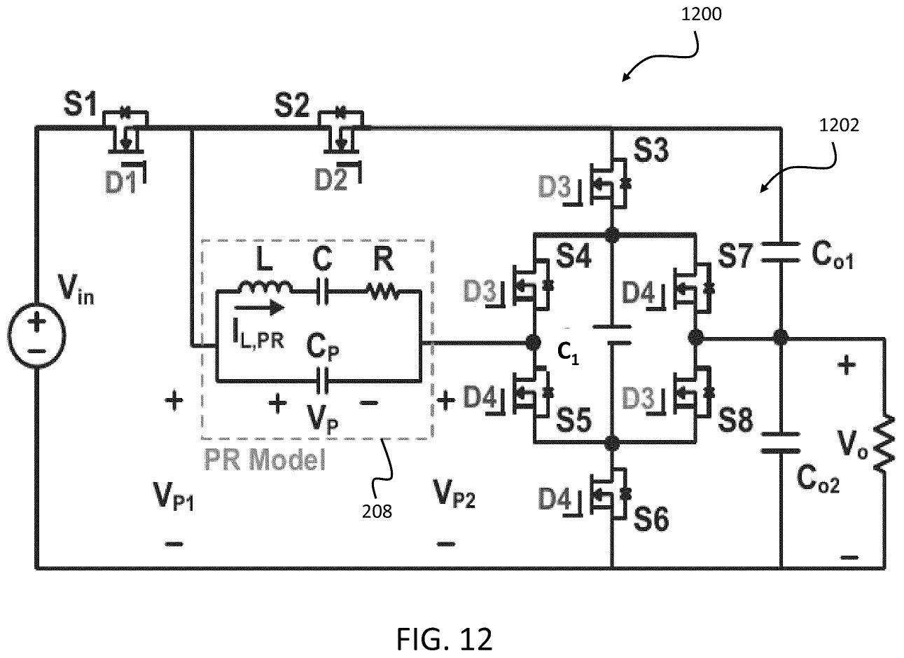

FIG. 12 is a circuit diagram of a preferred backside series/parallel piezoelectric resonator converter 1200. An SC network 1202 is on the backside of the baseline PR converter, incorporating the output half-bridge structure of the baseline PR converter 208, including switches S3-6, and additional switches S7,8 along with a flying capacitor, C₁. This configuration forms a 2:1 series/parallel SC network to the output, where C₁ is controlled by driving signals D3 and D4 that position it either in series or parallel with the output. Notably, due to its series/parallel arrangement with the output, C₁ is inherently self-balanced to the output voltage, Vₒ, effectively reducing the control complexity.

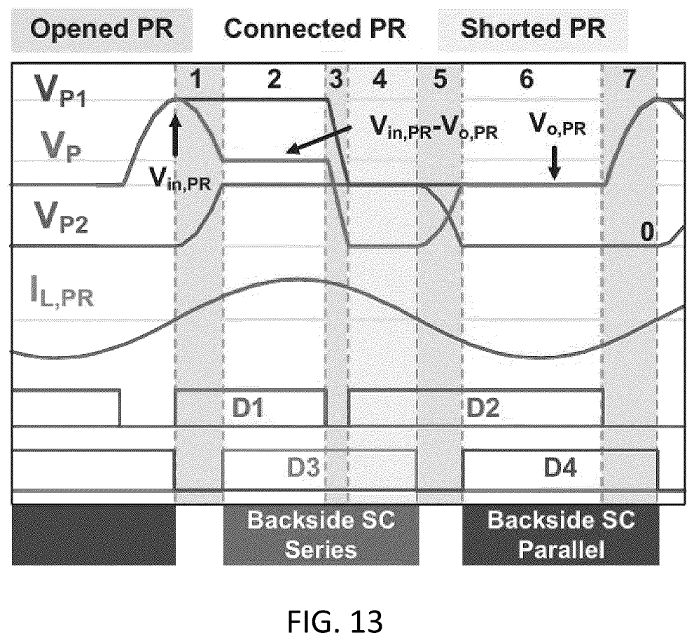

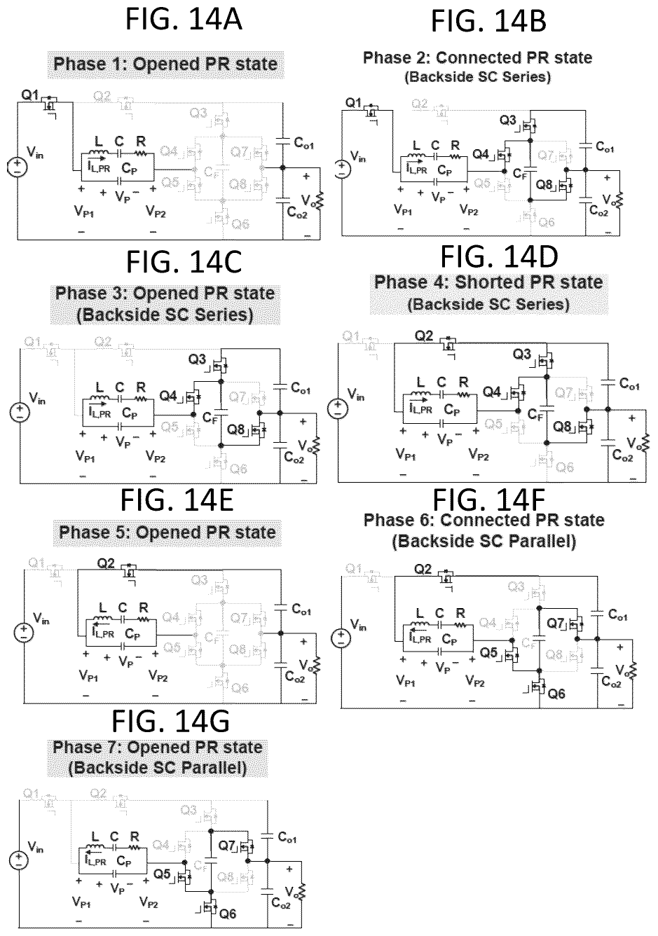

The operation waveforms and phases are of the converter 1200 are respectively illustrated in FIGS. 13 and 14A-14G where V_{in,PR} and V_{o,PR} represent the equivalent input/output voltage for PR stage. Here, V_{in,PR} is the input voltage, Vᵢₙ while V_{o,PR} is twice the output voltage, 2V, in the converter 1200. There are 7 individual phases in a cycle (FIGS. 14A-14G), where the PR 208 can be arranged in one of three states: (1) opened PR, (2) connected PR, and (3) shorted PR states.

At the beginning, no current loop is formed by the switches in phase 1, leading to an open PR state. In this phase, the inductive PR current, I_{L,PR}, discharges C_{P}, where V_{P2} is correspondingly increased. As V_{P2} equals V_{o,PR}, the body diodes of S3 and S4 become forward-biased. This allows ZVS turn-on of S3, S4, and S8, entering phase 2 and making C₁ in series with the load. During phase 2, the PR is linked to both the input and output, transferring energy to the output while storing energy within the PR. The phase ends as S1 deactivates, transitioning to phase 3, an open PR state, where I_{L,PR} discharges C_{P} until V_{P1}=V_{o,PR}, assuring ZVS turnon for S2. Then, phase 4 initiates, creating a shorted loop to ensure the current continuity and this free-wheeling phase terminates when the polarity of I_{L,PR} reverses, after which switches S3, S4, and S8 are opened. This puts the PR back to an open PR state, phase 5, where I_{L,PR} charges C_{P}, discharging V_{P2} until it becomes zero where body diodes of S5 and S6 are conducted with ZVS turn-on enabled for S5S 7. This consequently puts the C₁ in parallel with the load, and the PR is connected to the output and ground, entering the connected PR state, where the PR starts to release energy to the load. Phase 7 begins as S2 turns off, opening the PR. In this phase, I_{L,PR} charges C_{P} until V_{P1} reaches V_{in,PR}, ensuring ZVS turn-on for S1.

The PR 208 converter in the converter 1200 must follow conservation of energy and charge in steady state to balance charge and energy. Using (1) through (5) above, it can be found that the VCR is regulated by the ratio of phases 2 (connected state) and 4 (shorted state), which can also be translated into the ratio of the input connected time (phase 2) and the circulating time (phase 4). Therefore, an extended phase 2 interval implies a prolonged input-connected time leading to an increased VCR, and conversely, a shortened phase 2 interval leads to a reduced VCR. The converter 1200 reaches its maximum K of 1 at 0.25 VCR; on the other hand, the FIG. 1 PR converter presents a K of 0.67 at the same conversion ratio indicating a higher portion of circulating interval in the FIG. 1 PR converter, and consequently, a lower efficiency. The PR resonant current in the converter 1200 can be smaller than the converter 200 at the same output condition, leading to reduced I²R losses in the PR 208. The difference in resonant current arises because the PR 208 is relocated to the input side (high voltage/low current side) in the converter 1200 rather than being directly linked to the output (low voltage/high current side).

While specific embodiments of the present invention have been shown and described, it should be understood that other modifications, substitutions and alternatives are apparent to one of ordinary skill in the art. Such modifications, substitutions and alternatives can be made without departing from the spirit and scope of the invention, which should be determined from the appended claims.

Various features of the invention are set forth in the appended claims.

1. A DC-DC converter for converting an input voltage from a battery source, comprising a piezoelectric converter and a switched capacitor network between the battery source and the piezoelectric converter, wherein the switched capacitor network provides a flying capacitor C₁ configured to be soft-charged and soft discharged due to an inductive operation of the piezoelectric converter such that charge-sharing loss of the flying capacitor C₁ is eliminated.

2. The DC-DC converter of claim 1, wherein the switched capacitor network comprises a pre-step-down stage.

3. The DC-DC converter of claim 1, wherein the switched capacitor network comprises:
switches S1-S4 and the flying capacitor C₁ in a configuration to be switched between series and parallel modes with respect to the piezoelectric converter, wherein:
in the series mode, the switches S1 and S3 are turned on, putting the flying capacitor C₁ in series with the piezoelectric converter;
in the parallel mode, the switches S2 and S4 are turned on, putting the flying capacitor C₁ in parallel with the PR-based piezoelectric converter stage.

4. The DC-DC converter of claim 3, wherein the configuration clamps flying capacitor C₁ to half of the input voltage, thereby lowering voltage stress of the switches S1-S4 and providing a pre-step down of the input voltage prior to the piezoelectric converter.

5. The DC-DC converter of claim 1, comprising an output a switched capacitor network between the piezoelectric converter and an output, wherein the switched capacitor network provides a backside flying capacitor C_{F2} configured to be self-balanced by the piezoelectric converter.

6. The DC-DC converter of claim 5, wherein the converter is arranged such that the piezoelectric converter operates in one of three states of opened, connected and shorted.

7. The DC-DC converter of claim 6, wherein the switched capacitor network and the output switched capacitor network are configured to:
create the opened state by deactivating switches;
create the connected state by soft-charging and then soft-discharging C₁ while C_{F2} is in series with the load;
create the shorted state in which current circulates until polarity reverses and then return to the opened state placing C_{F2} is in parallel with the load to link the piezoelectric converter to the output.

8. A DC-DC converter for converting an input voltage from a battery source, comprising a piezoelectric converter and a switched capacitor network between the piezoelectric converter and an output, wherein the switched capacitor network provides a flying capacitor C₁ configured to be soft-charged and soft discharged due to an inductive operation of the piezoelectric converter such that charge-sharing loss of the flying capacitor C₁ is eliminated.

9. The converter of claim 8, wherein the switched capacitor network forms a 2:1 series/parallel SC network to the output, where C₁ is controlled by driving signals D3 and D4 that position it either in series or parallel with the output.
